(19) United States
(12) Patent Application Publication
(10) Pub. No.: US 2007/0123620 A1
(43) Pub. Date: May 31, 2007

(54) Radiation resistant polypropylene useful in medical applications

(75) Inventors: Kasinath Nayak, Odessa, TX (US); Gerald Cummings, Racine, WI (US); Roger Merrill, Odessa, TX (US)

Correspondence Address: Huntsman Corporation;Legal Department, 10003 Woodloch Forest Drive, The Woodlands, TX, 77380, US

(73) Assignee: Huntsman Polymers Corporation, Odessa, TX (US)

(21) Appl. No.: 10/582,189

(22) PCT Filed: Dec. 2, 2004
(86) PCT No.: PCT/US04/40366

§ 371 Date: Jun. 8, 2006

Related U.S. Application Data
(60) Provisional application No. 60/527,795, filed on Dec. 8, 2003.

(51) Int. Cl. C09D 11/02

(52) U.S. Cl. 524/251; 524/394

(57) ABSTRACT

Blends useful as an additive in polyolefin polymers for minimizing the effects of radiation on the physical properties of polymers, which comprises a hindered amine light stabilizer and at least one material selected from the group consisting of: i) amine oxides and ii) hydroxylamines. Various articles of manufacture may be produced using a composition or blend according to the invention, and the physical properties of such articles are less effected by electromagnetic radiation than like-kind compositions of the prior art.

### FIELD OF THE INVENTION

This invention relates to the development of an improved clear, color-stable, and radiation-sterilizable polypropylene for various medical applications, including syringes and other wares normally fabricated from what is recognized in the art as radiation-sterilizable polyolefins.

### BACKGROUND INFORMATION

U.S. Pat. No. 4,666,959 teaches the use of a polymeric hindered amine light stabilizer, an alkyl phosphite and a specific phenolic antioxidant as necessary additives to protect polypropylenes from the exposure to high energy “gamma” radiation. U.S. Pat. No. 4,888,369 teaches very similar art as the previous one, except it teaches the use of an additive termed as mobilizer, such as hydrocarbon oil. Although the teachings of these patents are helpful to prevent degradation of polypropylenes from exposure to high energy radiation, the main drawbacks are the yellowing of parts made from the teachings therein due to the presence of hindered phenolic antioxidants. U.S. Pat. No. 6,231,936 claims the radiation tolerant polypropylene composition comprising of polypropylene and polyethylene (1-50%) produced by single-site catalyst along with additives such as hindered amine stabilizers, secondary antioxidants (i.e., phosphites and thioesters), sorbitol type clarifiers. However secondary antioxidants such as phosphites are susceptible to hydrolysis upon exposure to moisture prior to or during extrusion. Also, in the real world case scenario, most of these phosphites are recognized by those skilled in the art as being the cause of black specks in the resin which show up in the molded parts thereafter. This patent also claims the use of thiodipropionate secondary antioxidant selected from the group consisting of distearyl thiopropionate and dilaurylthiopropionate. These sulfur containing additives are known to impart odor. This patent also claims the addition of a sorbitol type clarifying agent (i.e., bis-4-methylbenzylidene sorbitol and bis-3,4-dimethylbenzylidene sorbitol) up to 0.5% to enhance clarity of molded parts. However, sorbitol type clarifying agents impart cherry flavored odor, and in some severe autoclave conditions (per 9 CFR 121 condition A), they form flocculates. U.S. Pat. No. 5,376,716 describes a radiation resistant resin suitable for the manufacture of disposable medical devices comprising of a semicrystalline polypropylene or propylene-ethylene copolymer with 1500-5000 ppm of triallyl trimellitate as well as a phosphite.

The presentation “New Improvements in Radiation Resistant Polypropylenes” presented at the Fifth International Conference Additives in 1996 showed the formulations consisting of special additives combinations of hindered amine light stabilizers (“HALS”) and phosphites improved the color-stability of polypropylenes after exposure to gamma radiation.

The polypropylenes commonly contain a hindered phenolic antioxidant along with a secondary antioxidants such phosphites and thioesters as the processing stabilizers. However, upon exposure to gamma radiation, it exhibits undesirable color due to generation of color-bodies from the oxidized hindered phenolic type primary antioxidants. A non-hindered phenolic additive system for such applications is desired. Although addition of a phosphite prevents the discoloration, the phosphite is also the main source of causing black specks in the products during the end-use applications. Although thioesters are good processing as well as thermal stabilizers, they do impart odor, which is not acceptable for most medical uses. Hence, this invention relates to an additive composition that is free of both hindered phenolics, and secondary antioxidants such as phosphites and thioesters. It comprises a combination of a hindered amine light stabilizer and an amine oxide, or a combination of hindered amine light stabilizer and hydroxyl amine compounds that provided excellent color stability after exposure to gamma radiation up to 5 mrads. Also addition of clarifier such as NA-21 (Amfine Chemical Corporation) imparted excellent clarity.

The present invention remedies the aforementioned deficiencies by achieving better color stability along with enhanced clarity and impact resistance. A polypropylene random copolymer (nominal MFRs and 9 and ˜25 dg/min @ 230 C/2.16 kg per ASTM D-1238) consisting of: I) a combination of hindered amine light stabilizer (“HALS”) and an amine oxide along with an acid neutralizer (i.e., metallic stearate) or II) a combination of HALS and hydroxyl amine along with an acid neutralizer was exposed to gamma radiation up to 5 mrads. The results indicated that HALS/amine oxide or HALS/hydroxylamine maintained excellent color stability, even showing very little increase in yellowness index after exposure to gamma radiation. Addition of a new clarifier NA-21(Amfine, Allendale, N.J.) imparted better clarity having less effect on tensile and impact properties unlike sorbitol based clarifier such as MILLAD® 3988 (Milliken Chemical Co, Spartanburg, S.C.). Addition of a metallocene catalyzed polyethylene polymer and Ziegler-Natta catalyzed polyethylene containing octene as a comonomer improved the impact strength of the polymer after being exposed to gamma radiation.

### SUMMARY OF THE INVENTION

The present invention provides a blend useful as an additive in polyolefin polymers for minimizing the effects of radiation on the physical properties of said polymers, which comprises a hindered amine light stabilizer and at least one material selected from the group consisting of: i) amine oxides exemplified by the formula: 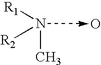
in which R₁ and R₂ are each independently selected from C₁₀ to C₂₄ alkyl, aryl, or alkylaryl groups, whether straight-chain, branched, cyclic, saturated, or unsaturated; and ii) hydroxylamines exemplified by the formula: 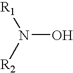
in which R₁ and R₂ are each independently selected from C₁₀ to C₂₄ alkyl, aryl, or alkylaryl groups, whether straight-chain, branched, cyclic, saturated, or unsaturated.

### DETAILED DESCRIPTION

Semi-crystalline polymers such as polypropylene are used in medical devices, and food packaging where these articles are frequently subjected to ionizing radiation for sterilization. It is known that exposure of polymers such as polypropylene to high-energy radiation i.e., electron beam or gamma radiation triggers radiation induced chemical reactions with predominant chain scission mechanism, resulting in loss of physical properties. Such property losses include embrittlement and discoloration, and are not acceptable to end-use applications.

The present invention provides novel formulations of polypropylene compositions that are radiation resistant, color-stable and clear. In accordance with the present invention, polypropylene and propylene-ethylene copolymer compositions comprise of the following components in amounts equal to about: i) 0.01-0.2 wt % hindered amine light stabilizer (“HALS”); ii) 0.01-0.1 wt % amine oxide; iii) 0.01-0.2 wt % hydroxyl amine; iv) 0.01-0.3 wt % clarifier or nucleator; and v) 0.01-0.2 wt % acid neutralizer. The general chemical formulae for amine oxides and hydroxyl amines are illustrated as:

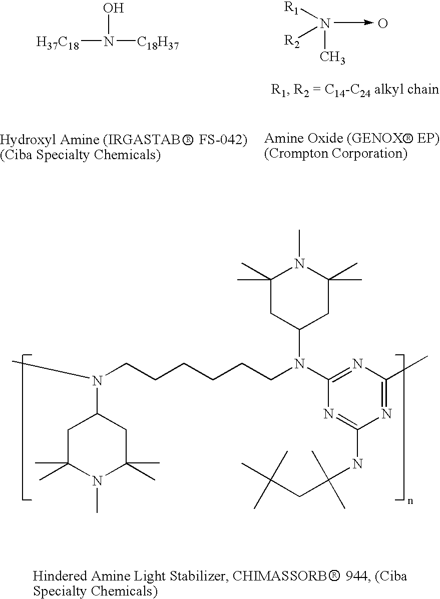

A combination (1:2) of amine oxide (GENOX® EP) and HALS or 1:1 blend of hydroxyl amine (FS-042) with HALS (CHIMASSORB® 944) more commonly known as IRGASTAB® FS 410 were thoroughly tested, and compared to those of prior art. Individual additives in various radiation-resistant formulations include: Naugard XL-1 (CAS #70331-94-1, 2,2′-oxiamidobisethyl 3(3,5-di-tert-butyl-4-hydroxyphenyl)propionate, Crompton Corporation); TINUVIN® 622LD (CAS #65447-77-0, Dimethyl succinate polymer with 4-hydroxy-2,2,6,6-tetramethyl-1-piperidineethanol; Ciba Specialty Chemicals); CHIMASSORB® 944LD (CAS #71878-19-8; N,N′-bis(2,2,6,6-tetramethyl-4-piperidinyl)-1,6-hexanediamine polymer with 2,4,6-trichloro-1,3,5-triazine and 2,2,4-trimethyl-1,2-pentaamine, Ciba Specialty Chemicals); GENOX® EP (CAS #204933-93-7; Dialkyl methyl amine oxide; Crompton Corporation); IRGASTAB® FS410 (1:1 blend of IRGASTAB® FS042 and CHIMASSORB® 944LD from Ciba Specialty Chemicals); DHT-4A (CAS # 11097-59-9; Synthetic hydrotalcite; Kyowa Chemical); Calcium Stearate (CAS # 1592-23-0; Crompton Corporation); PEP-36 (CAS #80693-00-1; Bis (2,6-di-tert-butyl-4-methylphenyl)pentaerythritol-di-phosphite; Amfine Chemical) ULTRANOX® 641 (CAS #161717-32-4; 2,4,6-tri-tert-butylphenyl 2, butyl 2ethyl 1,3prpane diol phosphite; Crompton Corporation); and WESTON® 619 (CAS #3806-34-6, Distearyl Pentaerythritol Diphosphite; Crompton Corporation).

Additives useful for improving clarity and nucleation in polyolefin polymers include: MILLAD® 3988 (CAS # 135861-56-1; Bis 3,4,-dimethylbenzylidene sorbitol, from Milliken Chemical); HPN-68 (CAS # 351870-33-2, Proprietary inorganic salt from Milliken Chemical); NA-21 (Proprietary inorganic salt from Amfine Chemical); NA-11 (CAS #85209-91-2, Sodium 2,2′-methylene-bis-(4,6-di-tert-butylphenyl) phosphate; from Amfine Chemical); and KM-1500 (CAS #1309-43-4 and 68440-56-2; Magnesium Salt of disproportionated rosin acid; Mitsui&Co).

Impact Modifier additives useful for improving impact properties in polyolefin polymers include: ENGAGE® 8200 polyethylene (CAS #026221-73-8); DuPont Dow Chemical); Catalyst LL-1002.09 (CAS #25087-34-7, Ziegler-Natta Catalyzed Linear Low Density polyethylene with butene comonomer; ExxonMobil Chemicals); and Catalyst L8101 (CAS #26221-73-8, Ziegler-Natta Catalyzed Linear Low density polyethylene with octene comonomer; Huntsman Polymers Corporation, Odessa, Tex.)

An unexpected result of the invention includes improved color stability, enhanced clarity, and improved impact resistance after being exposed to gamma radiation without use of conventional phosphite and thioesters. The present invention is exemplified by what is contained in the examples now presented, and shall not be construed as being limited thereby in any fashion.

### EXAMPLE 1

The formulations A1 through N1 are given in Tables 1 and 2. Several formulations had hindered amine light stabilizer (HALS)/phosphites. The phosphites used are ULTRANOX® 641 phosphite (Crompton Corporation, Middlebury, Conn.), WESTON® 619 phosphite (Crompton Corporation, Middlebury, Conn.), DOVERPHOS® S-9228T phosphite (Dover Chemical, Dover, Ohio), PEP-36 (Amfine, Allendale, N.J.). Also, clarifiers/nucleators such as MILLAD® 3988 (Milliken Chemical Spartanburg, SC, HPN-68 (Milliken Chemical, Spartanburg, S.C.), NA-21 (Amfine Chemical, Allendale, N.J.), and KM1500 (Mitsui Chemical) were added at specified levels. The hindered amine light stabilizers are TINUVIN® 622 HALS and CHIMASSORB® 944 HALS (Ciba Specialty Chemicals, Tarrytown, N.Y.). The amine oxide is GENOX® EP amine oxide (Crompton Corporation, Middlebury, Conn.). The impact modifier chosen was ENGAGE® 8200 polyethylene (DuPont-Dow). The specific formulations were pre-blended with un-stabilized polypropylene random copolymer powder (MFR ˜12 g/10 min), and then melt extruded by a Haake TW100 twin screw extruder at a processing temperature of 230° C. Test specimens were molded on a 120-ton Van Dom injection-molding machine under ASTM Conditions. Specimens were irradiated at 2.0 and 4.0 mrads by Isomedix, Whippany, N.J. using a ⁶⁰Co source. Control specimens (i.e., non-radiated) were included in each physical test for comparison. Yellowness Index was measured with a Colorgard/05 from BYK Gardner as per ASTM D-1925. Tensile properties were measured on Typ1-I injection molded tensile bars with an Instron 1125 universal testing machine with an initial grip separation of 2.5″ and an extension rate of 5″/min. Melt flow rate (MFR) was measured with a Kayness Galaxy I melt indexer as per ASTM-1238B. Multiaxial impact energy was measured by Dynatup 8250, using velocity of 4.3 m/sec and crosshead weight of 28 lbs (12.7 kg).

Effect of Gamma Radiation on MFR: The % change in MFR after exposing the samples at 2 and 4 mrads are given in tables 1 and 2. Sample K1 (containing CHIMASSORB® 944 @ 0.15% and ULTRANOX® 641 @ 0.1%) had the least increase of 316.7% in MFR after 2 mrads of exposure, whereas sample F1 (control-containing 0.2% TINUVIN® 622+0.1% WESTON® 619) had the highest increase of 671.7%. At 4.0 mrads of exposure, sample M1 (0.15% CHIMASSORB® 944+0.1% PEP-36+2.5% ENGAGE® 8200) had the least increase of MFR, whereas Sample F1 (Control sample) had the highest increase in MFR of 1704.3%. Sample J1 (containing CHIMASSORB® 944 @ 0.1%, and GENOX® EP @ 0.05%) had the corresponding increase of 325% and 741.7% at 2.0 and 4.0 mrads of exposure, showing that it was relatively more stable compared to the control sample F1.

In all tables herein, all amounts given in formulations are specified in percentages on a weight basis, based on the total weight of the compositions provided.

TABLE 1

| | Sample ID | | | | | | |
|---|---|---|---|---|---|---|---|
| | A1 | B1 | C1 | D1 | E1 | F1 | G1 |
| PP Powder (MFR ˜10 dg/min) | 99.575 | 99.525 | 99.495 | 99.425 | 99.495 | 99.23 | 99.475 |
| CHIMASSORB ® 944 | 0.15 | 0.15 | 0.15 | 0.15 | 0.15 | | 0.15 |
| TINUVIN ® 622 | | | | | | 0.2 | |
| ULTRANOX ® 641 | 0.1 | 0.1 | 0.1 | 0.1 | 0.1 | | 0.1 |
| DOVERPHOS ® S-9228T | | | | | | | |
| Genox EP | | | | | | | |
| Calcium Stearate | 0.05 | 0.05 | 0.05 | 0.05 | 0.05 | 0.1 | 0.05 |
| DHT-4A | 0.025 | 0.025 | 0.025 | 0.025 | 0.025 | 0.05 | 0.025 |
| Naugard XL-1 | | | | | | 0.07 | |
| Weston 619 | | | | | | 0.1 | |
| NA-21 | 0.1 | 0.15 | 0.18 | 0.1 | | | |
| Millad 3988 | | | | 0.15 | 0.18 | 0.25 | 0.15 |
| NA-11 | | | | | | | 0.05 |

Physical Properties
at 0.0 Mrads

| | | | | | | | |
|---|---|---|---|---|---|---|---|
| MFR (g/10 min) | 12 | 11 | 11 | 11 | 11 | 9.2 | 12 |
| % Strain at Yield | 13.5 | 13.6 | 13.9 | 14 | 13.9 | 12.4 | 14.1 |
| Stress at Yield, psi | 4200 | 4220 | 4220 | 4270 | 4350 | 4570 | 4340 |
| % Strain at Break | 560 | 580 | 570 | 610 | 660 | 650 | 650 |
| Stress at Break, psi | 2760 | 2770 | 2780 | 2770 | 2850 | 2910 | 2860 |
| Multiaxial Impact @ 23° C., in- | 250(112) | 278(114) | 254(73) | 52(29) | 27(13) | 21(4) | 157(84) |
| lbs | | | | | | | |
| Yellowness Index | 4.5 | 4 | 3.9 | 4.6 | 4.8 | 4.2 | 4.8 |
| % Haze-25 mil | 8.5 | 7.8 | 7.3 | 8.3 | 8.6 | 10.7 | 9.1 |
| % Haze-50 mil | 23.2 | 21.6 | 20.7 | 22.5 | 21 | 22.6 | 21.1 |
| Crystallization Temp (° C.) | 118.3 | 119.6 | 119.4 | 119.7 | 119.9 | 120.9 | 121 |

at 2.0 Mrads

| | | | | | | | |
|---|---|---|---|---|---|---|---|
| MFR (g/10 min) | 51 | 55 | 56 | 63 | 59 | 71 | 55 |
| % Strain at Yield | 13.6 | 13.7 | 13.7 | 14.1 | 13.8 | 11.9 | 14 |
| Stress at Yield, psi | 4170 | 4190 | 4190 | 4230 | 4320 | 4570 | 4350 |
| % Strain at Break | 630 | 620 | 620 | 440 | 510 | 340 | 570 |
| Stress at Break, psi | 2720 | 2740 | 2730 | 2670 | 2760 | 2620 | 2770 |
| Multiaxial Impact @ 23° C., in- | 111 | 167 | 131 | 24 | 27 | 22 | 93 |
| lbs | | | | | | | |
| Yellowness Index | 4.6 | 4.4 | 4.5 | 5.2 | 5.8 | 6.2 | 6.5 |

4.0 Mrads

| | | | | | | | |
|---|---|---|---|---|---|---|---|
| MFR (g/10 min) | 147 | 118 | 129 | 113 | 127 | 166 | 137 |
| % Strain at Yield | 14.4 | 14 | 14.2 | 13.6 | 14.2 | 13.1 | 13.9 |
| Stress at Yield, psi | 4150 | 4200 | 4190 | 4330 | 4470 | 4590 | 4400 |
| % Strain at Break | 690 | 660 | 640 | 330 | 340 | 170 | 270 |
| Stress at Break, psi | 2720 | 2690 | 2690 | 2640 | 2670 | 3410 | 2690 |
| Multiaxial Impact @ 23° C., in- | 55 | 85 | 43 | 18 | 15 | 15 | 35 |
| lbs | | | | | | | |
| Yellowness Index | 5.4 | 4.8 | 5.4 | 5.7 | 7 | 6.5 | 7 |
| % Change in MFR (@ 2 Mrads) | 325 | 400 | 409.1 | 472.7 | 436.4 | 671.7 | 358.3 |
| % Change in MFR (@4 Mrads) | 1125 | 972.7 | 1072.7 | 927.3 | 1054.5 | 1054.5 | 883.3 |
| Diff. In YI (2.0-0 Mrads) | 0.1 | 0.4 | 0.6 | 0.6 | 1 | 2 | 1.7 |
| Diff. In YI (4.0-0 Mrads) | 0.9 | 0.8 | 1.5 | 1.1 | 2.2 | 2.3 | 2.2 |

Effect of Nucleator/Clarifiers: Since, gamma radiation on clarity of PP has negligible effect, the step-plaques (25/50 mils) were not subjected to gamma radiation. The % haze (for 25 mil plaque) of samples A1, B1, and C1 (containing NA-21 @ 0.1, 0.15, and 0.18% respectively) were 8.5, 7.8, and 7.3 respectively, showing very excellent enhancement in clarity. The corresponding % haze for 50 mil plaques were 23.2, 21.6, and 20.7 respectively, showing excellent clarity. The percentage of haze in samples E1 and L1 (Duplicate run—both containing Millad 3988 @ 0.18%) were 8.6 and 6.3 respectively; showing some variability. However, this might be attributed to the dispersion of MILLAD® 3988 (i.e., poor dispersion may cause higher % haze). Hence in a reactor grade PP, both NA-21 and MILLAD® 3988 imparted similar enhancement in clarity (i.e., reduction in % haze). Samples M1 and N1 (containing 2.5% and 5% ENGAGE® 8200) had the % haze (25 mil) of 8.2 and 9.3 respectively. This indicated that the modifier (i.e., ENGAGE® 8200) had very little effect on clarity. Combination of MILLAD® 3988/HPN-68 (@ 0.15%/0.05%) in samples H1, J1 and I1 imparted % haze values of 9.2, 7.4, and 7.5 units, measured on 25 mil thick plaques. Also, these three samples had crystallization temperatures almost 2° higher than that of sample C1 (containing NA-21 @ 0.18%). Higher crystallization temperature normally results in lower cycle time, and higher productivity.

Effect of Gamma Radiation on Yellowness Index: The initial colors of samples A1 through N1 were in the range of 2.1-5.4 units. Sample H1 had the highest initial color of 5.4. The control sample F1 had the initial color of 4.2 units, 6.2 units @ 2 mrads, and 6.5 units @ 4 mrads, thus an increasing trend in yellowness index with increase of dosage of gamma radiation. Sample I1 (0.15% C-944+0.1% DOVERPHOS® S-9228T) had initial color of 4.3 @ 0.0 mrads, 3.9 units @ 2.0 mrads, and 3.9 units @ 4.0 mrads, thus showing slight decrease in yellowness index with increase in dosage of gamma radiation. Sample J1 (0.1% C-944+0.05% GENOX® EP had initial color of 4.6 units, 2.3 units @ 2 mrads, and 2.6 units @ 4 mrads, thus showing decrease in yellowness index with increase in dosage of gamma radiation. All other formulations showed an increase in yellowness index with increase of the dosage of gamma radiation.

TABLE 2

| | Sample ID | | | | | | |
|---|---|---|---|---|---|---|---|
| | H1 | I1 | J1 | K1 | L1 | M1 | N1 |
| PP Powder | 99.475 | 99.475 | 99.575 | 99.475 | 99.495 | 99.875 | 99.375 |
| CHIMASORB 944 | 0.15 | 0.15 | 0.15 | 0.15 | 0.15 | 0.15 | 0.15 |
| TINUVIN 622 | | | | | | | |
| ULTRANOX 641 | 0.1 | — | — | 0.01 | 0.01 | 0.01 | 0.01 |
| DOVERPHOS-9228T | — | 0.01 | — | — | — | — | — |
| GENOX EP | — | — | 0.05 | — | — | — | — |
| Ca stearate | 0.05 | 0.05 | 0.05 | 0.05 | 0.05 | 0.05 | 0.05 |
| DHT-4A | 0.025 | 0.025 | 0.025 | 0.025 | 0.025 | 0.025 | 0.025 |
| MILLAD 3988 | 0.15 | 0.15 | 0.15 | 0.15 | 0.18 | 0.15 | 0.15 |
| HPN-68 | 0.05 | 0.05 | 0.05 | — | — | 0.05 | 0.05 |
| KM-1500 | — | — | — | 0.05 | — | — | — |
| PEP-36 | — | — | — | — | — | 0.1 | 0.1 |
| EXXACT 8200 | — | — | — | — | — | 2.5 | 5 |

Physical Properties of Samples from above
at 0 megarads

| | | | | | | | |
|---|---|---|---|---|---|---|---|
| MFR | 12 | 12 | 12 | 12 | 12 | 11 | 12 |
| % strain @ yield | 14.3 | 14.2 | 14.2 | 14.3 | 3.9 | 14.9 | 15.4 |
| Stress @ yield (psi) | 4290 | 4250 | 4260 | 4320 | 4360 | 4020 | 3880 |
| % strain @ break | 630 | 610 | 620 | 620 | 700 | 590 | 630 |
| Stress @ Break (psi) | 2790 | 2800 | 2810 | 2820 | 2850 | 2750 | 2740 |
| multiaxial impact @ | 257 | 301 | 285 | 278 | 318 | 334 | 325 |
| 23° C., in-lbs | | | | | | | |
| yellowness index | 5.4 | 4.3 | 4.6 | 4.6 | 5.9 | 3.7 | 2.1 |
| % haze 25 mil | 9.2 | 7.4 | 7.5 | 8.1 | 6.3 | 8.2 | 9.3 |
| % haze 50 mil | 21.6 | 19.6 | 18.9 | 20.5 | 14.3 | 20.6 | 23.7 |
| crystallization temp. | 121.5 | 122.5 | 122.5 | 120.1 | 120.9 | 121.9 | 122 |

at 2.0 megarads

| | | | | | | | |
|---|---|---|---|---|---|---|---|
| MFR (g/10 min) | 58 | 62 | 51 | 50 | 54 | 47 | 57 |
| % strain@yield | 14.2 | 14.2 | 14.2 | 13.8 | 14.1 | 14.5 | 15.3 |
| stress@yield, psi | 4280 | 4260 | 4280 | 43410 | 4400 | 4080 | 3880 |
| % strain@break | 480 | 320 | 640 | 530 | 670 | 580 | 580 |
| stress@break (psi) | 2700 | 2680 | 2800 | 2770 | 2870 | 2720 | 2690 |
| multiaxial impact | 131 | 106 | 201 | 160 | 155 | 291 | 307 |
| @23° C., in-lbs | | | | | | | |
| yellowness index | 6.9 | 3.9 | 2.3 | 4.7 | 5.1 | 6.7 | 5.7 |

at 4.0 megarads

| | | | | | | | |
|---|---|---|---|---|---|---|---|
| MFR (g/10 min) | 118 | 107 | 101 | 129 | 116 | 91 | 117 |
| % strain@yield | 13.6 | 14 | 14.3 | 13.7 | 14 1 | 4.5 | 15.1 |
| stress@yield, psi | 4300 | 4290 | 4270 | 4320 | 4380 | 4060 | 3880 |
| % strain@break | 280 | 270 | 290 | 300 | 340 | 370 | 570 |
| stress@break (psi) | 2670 | 2640 | 2640 | 2650 | 2690 | 2610 | 2610 |
| multiaxial impact @ | 58 | 45 | 37 | 50 | 31 | 243 | 294 |
| 23° C., in-lbs | | | | | | | |
| yellowness index | 7.7 | 3.9 | 2.6 | 6 | 6.2 | 5.1 | 4.5 |
| % in MFR @ 2.0 | 383.3 | 416.7 | 326 | 316.7 | 350 | 327.3 | 375 |
| megarads | | | | | | | |
| % in MFR @ 4.0 | 883.3 | 791.7 | 741.7 | 975 | 866.7 | 727.3 | 875 |
| megarads | | | | | | | |
| in YI (0-2.0 | 1.5 | −0.4 | −2.3 | 0.1 | −0.8 | 3 | 3.6 |
| megarads) | | | | | | | |
| in YI (2.0-4.0 | 2.3 | −0.4 | −2 | 1.4 | 0.3 | 1.4 | 2.4 |
| megarads) | | | | | | | |

Effect of Gamma Radiation on Tensile Properties: % Strain @ yield was unaffected by increase in dosage of gamma radiation. % Strain @ break was affected to some degree with increase in dosage of gamma radiation. At 2.0 mrads of exposure, the losses in % strain at break of various formulations were in the range of 1.7%-47.5%; Sample F1 had the highest loss of % strain at break. M1 (containing 2.5% ENGAGE® 8200) had 1.7% loss of strain at break at 2.0 mrads and 37.3% loss at 4 mrads of exposure respectively. Sample N1 (containing 5% ENGAGE® 8200) had the corresponding loss of 7.9% and 9.5% at 2 and 4 mrads respectively. Hence, it is evident that addition of ENGAGE® 8200 (@ 2.5-5%) helped to maintain the % strain at break.

Effect of Gamma Radiation on Multiaxial Inpact: Multi-axial impact of samples A1 through N1 were measured by 8250 Dynatup with an impact of 26 lbs under acceleration due to gravity. The initial impact values varied from 21 in-lbs to 334 in-lbs. It was evident that the samples containing MILLAD® 3988 had the least impact values compared to the samples containing NA-21. The loss of impact at 2 mrads were in the range of 0-55.6%. The loss of impact at 4 mrads were in the range of 9.5-89.4%, showing a higher degree of loss at this dosage of gamma radiation. Sample M1 (containing 2.5% ENGAGE® 8200) had a loss of ˜27% in impact; whereas sample N1 (containing 5% ENGAGE® 8200) had only 9.5% loss of impact. Hence, it is evident that addition of ENGAGE® 8200 helped to maintain impact properties at higher dosage of gamma radiation.

### EXAMPLE 2

In the second example, some of the formulations of example-1 were repeated. Here the base resin chosen was a random copolymer polypropylene, having melt flow rate of 25 gm/10 min. The formulations (A2-C2) are given in Table-3. Sample B2 contained modifier ENGAGE® 8200 @ 2.5%, and sample C2 contained a linear low density polyethylene available from Huntsman Polymers Corporation of Odessa, Tex. under the tradename of “LLDPE L8101”, which is an octene copolymer. All these formulations were pre-blended with an un-stabilized random copolymer having MFR ˜25 g/10 min, and then were compounded by a 2.5″ Davis Standard single screw extruder at a processing temperature (210° C.). The test specimens (prepared—as described in example-1) were irradiated at 2.5 and 5.0 mrads of gamma radiation by Isomedix, Whippany, N.J. All these samples were tested as described in example 1.

The yellowness indices of these formulations had very minimal increase at 5 mrads of exposure vs. those of non-radiated samples, showing excellent color stability. Samples C2 had relatively lower increase in MFR at 5.0 mrads. This could be attributed to the presence of a LLDPE (L8101 @ 5 wt %) resulting in crosslinking. Addition of impact modifier such as ENGAGE® 8200 (even @ 2.5%) resulted in better impact energy than the control sample. Addition of L8101 @ 5 wt % did not provide much improvements in impact resistance.

TABLE 3

| | Sample ID | | |
|---|---|---|---|
| | A2 | B2 | C2 |
| PP Powder | 99.55 | 97.05 | 94.55 |
| CHIMASORB 944 | 0.15 | 0.15 | 0.15 |
| GENOX EP | 0.05 | 0.05 | 0.05 |
| Ca stearate | 0.05 | 0.05 | 0.05 |
| DHT-4A | 0.025 | 0.025 | 0.025 |
| ENGAGE 8200 | — | 2.5 | — |
| NA-21 | 0.175 | 0.175 | 0.175 |
| L8101 | — | — | 5 |

Physical Properties of Samples from above

| Sample | | |
|---|---|---|
| A2 | B2 | C2 |

at 0 megarads

| | | | |
|---|---|---|---|
| MFR (g/10 min.) | 26.8 | 26.9 | 23.8 |
| % strain @ yield | 13.8 | 14.2 | 14 |
| Stress @ yield (psi) | 4010 | 3800 | 3830 |
| % strain @ break | 650 | 640 | 370 |
| Stress @ Break (psi) | 2590 | 2500 | 2490 |
| % haze 25 mil | 9.8 | 12.1 | 20.5 |
| % haze 50 mil | 27.9 | 33.5 | 44.1 |
| yellowness index | −0.11 | −2.4 | −1.44 |
| multi-axial impact @ 23° C., | 60 | 121 | 66 |
| in-lbs | | | |

at 2.5 megarads

| | | | |
|---|---|---|---|
| MFR (g/10 min) | 127 | 134 | 117 |
| % strain@yield | 13.9 | 14.7 | 14.2 |
| stress@yield, psi | 4020 | 3810 | 3830 |
| % strain@break | 480 | 640 | 370 |
| stress @ break (psi) | 2480 | 2480 | 2490 |
| % haze - 25 mil | 9.9 | 12.1 | 20.5 |
| % haze - 50 mil | 28 | 33.2 | 44.3 |
| yellowness index | 0.72 | −1.25 | 0.38 |
| multi-axial impact @23° C., | 52 | 91 | 42 |
| in-lbs | | | |

at 5.0 megarads

| | | | |
|---|---|---|---|
| MFR (g/10 min) | 365 | 339 | 230 |
| % strain@yield | 14.4 | 15 | 15 |
| stress @ yield, psi | 3990 | 3810 | 3810 |
| % strain @break | 360 | 460 | 590 |
| stress@break (psi) | 2380 | 2370 | 2410 |
| % haze - 25 mil | 10 | 12.3 | 20.6 |
| % haze - 50 mil | 27.8 | 33.6 | 44.3 |
| yellowness index | 1.29 | 0.49 | 0.75 |
| multi-axial impact @23° C., | 20 | 54 | 26 |
| in-lbs | | | |

### EXAMPLE 3

In this example, we have repeated some formulations as given in example 1 and also included FS410 as a primary stabilizer system (see Samples F3 and G3). The control formulation was sample D3. The additive formulations (shown in Table-4) with an un-stabilized polypropylene powder having initial MFR ˜25 dg/min were pre-blended and compounded by Haake TW100 twin screw extruder. The test specimens were irradiated at 2.5 and 5.0 mrads as done previously. The test specimens were tested as described in prior example 1.

The control sample D3 had YI colors of −1.79 (@ 0.0 mrads), 5.39(@2.5 mrads), and 5.91 (@5.0 mrads). The samples B3 (containing CHIMASSORB® 944 and GENOX® EP along with ENGAGE® 8200) had the least YI value of −1.67 after being exposed to 5 mrads of gamma radiation. Also the samples (F3 and G3) containing FS410 exhibited much lower YI (1.09 and 0.54 respectively) at 5 mrads' exposure. Hence, it is apparent that additive formulations consisting of either a combination of amine oxide and a HALS (i.e., CHIMASSORB® 994) or FS410 exhibited excellent color stability after being exposed to gamma radiation up to 5 mrads.

TABLE 4

| | Sample ID | | | | | | |
|---|---|---|---|---|---|---|---|
| | A3 | B3 | C3 | D3 | E3 | F3 | G3 |
| PP Powder | 99.625 | 94.625 | 99.475 | 94.23 | 99.575 | 99.575 | 99.625 |
| CHIMASORB 944 | 0.15 | 0.15 | 0.15 | — | 0.15 | — | — |
| GENOX EP | 0.05 | 0.05 | 0.05 | — | 0.05 | — | — |
| FS 410 | — | — | — | — | — | 0.2 | 0.2 |
| Ca stearate | 0.05 | 0.05 | 0.05 | 0.1 | 0.05 | 0.05 | 0.05 |
| DHT-4A | 0.025 | 0.025 | 0.025 | 0.05 | 0.025 | 0.025 | 0.025 |
| HPN-68 | 0.1 | 0.1 | — | — | 0.05 | 0.05 | 0.1 |
| Millad 3988 | — | — | — | 0.25 | — | — | — |
| NA-21 | — | — | — | — | 0.1 | 0.1 | — |
| ENGAGE 8200 | — | 5 | — | — | — | — | — |
| TINUVIN 622 LD | — | — | — | 0.2 | — | — | — |
| NAUGARD XL-1 | — | — | — | 0.07 | — | — | — |
| WESTON 619 | — | — | — | 0.1 | — | — | — |
| LL-1002.09 | — | — | — | 5 | — | — | — |

Physical Properties of Samples from above
at 0 megarads

| | | | | | | | |
|---|---|---|---|---|---|---|---|
| MFR (g/10 min) | 29 | 28 | 30 | 27 | 30 | 30 | 31 |
| crystallization temp | 125.8 | 125.1 | 121.9 | 122.3 | 125.8 | 125.1 | 121.9 |
| (° C.) | | | | | | | |
| % strain @ yield | 13 | 14.3 | 13.7 | 12 | 14.1 | 13.9 | 12.9 |
| Stress @ yield (psi) | 4300 | 3890 | 4540 | 4440 | 4270 | 4240 | 4380 |
| % strain @ break | 630 | 440 | 730 | 370 | 720 | 770 | 690 |
| Stress @ Break (psi) | 2670 | 2560 | 2790 | 2650 | 2680 | 2770 | 2850 |
| multiaxial impact @ | 42 | 225 | 29 | 80 | 61 | 40 | 29 |
| 23° C., in-lbs | | | | | | | |
| yellowness index | −0.98 | −3.67 | 0.36 | −1.79 | −0/34 | 0 | −0.73 |
| % haze 25 mil | 10.7 | 15.2 | 5.8 | 16.8 | 8.9 | 9.2 | 11.4 |
| % haze 50 mil | 24.7 | 35.8 | 13.6 | 32.8 | 22.4 | 23 | 24.3 |

at 2.5 megarads

| | | | | | | | |
|---|---|---|---|---|---|---|---|
| MFR (g/10 min) | 127 | 123 | 129 | 152 | 129 | 112 | 107 |
| crystallization temp | 125.7 | 125.4 | 121.7 | 122.7 | 123.8 | 122.8 | 125.6 |
| (° C.) | | | | | | | |
| % strain@yield | 13.4 | 14.3 | 13.6 | 11.9 | 13.8 | 13.2 | 12.6 |
| stress@yield, psi | 4280 | 3830 | 4540 | 4470 | 4270 | 4340 | 4350 |
| % strain@break | 200 | 300 | 460 | 320 | 610 | 600 | 610 |
| stress@break (psi) | 2500 | 2470 | 2650 | 2550 | 2570 | 2540 | 2540 |
| multiaxial impact | 26 | 77 | 22 | 32 | 33 | 30 | 30 |
| @23° C., in-lbs | | | | | | | |
| yellowness index | −0.13 | −2.15 | 1.24 | 5.39 | 0.57 | 0.46 | −0.27 |

at 5.0 megarads

| | | | | | | | |
|---|---|---|---|---|---|---|---|
| MFR (g/10 min) | 223 | 221 | 234 | 321 | 228 | 225 | 242 |
| crystallization temp | 125.4 | 124.9 | 121.8 | 121.2 | 123.1 | 121.6 | 124.9 |
| (° C.) | | | | | | | |
| % strain@yield | 12.6 | 14.1 | 13.5 | 11.7 | 13.9 | 13.7 | 13.5 |
| stress@yield, psi | 4400 | 3820 | 4540 | 4460 | 4270 | 4250 | 4240 |
| % strain@break | 520 | 320 | 240 | 340 | 210 | 200 | 190 |
| stress@break (psi) | 2540 | 2440 | 2560 | 2540 | 2420 | 2450 | 2470 |
| multiaxial impact @ | 16 | 50 | 16 | 24 | 24 | 21 | 28 |
| 23° C., in-lbs | | | | | | | |
| yellowness index | 0.38 | −1.67 | 1.77 | 5.91 | 1.09 | 1.09 | 0.54 |

### EXAMPLE 4

In this example, we have repeated some formulations as given in example 1 using a polypropylene copolymer having MFR ˜10 dg/min and also included FS410 as a primary stabilizer system (see Sample F4 in Table 4). The additive formulations with un-stabilized polypropylene powder having initial MFR ˜10 dg/min were pre-blended and compounded by Haake TW100 twin screw extruder. The test specimens were irradiated at 2.5 and 5.0 mrads of gamma radiation as done previously. The test specimens were tested as described in prior example 1.

The properties of these formulations (sample A4-F4) are given in Table 5. The sample B4 (containing CHIMASSORB® 944/GENOX® EP plus NA-21) had YI of 0.47 units (@ 0.0 mrads), 1.3 units (@2.5 mrads) and 1.76 units at (@5.0 mrads). Sample F4 (containing FS410 and NA-21) had the corresponding YI of 1.34, 2.44 and 2.52 units. Thus it is again evident that CHIMASSORB® 944 with either GENOX® EP (amine oxide) or FS042 (a hydroxyl amine) provided excellent color stability at 5 mrads of gamma radiation. Also, addition of MILLAD® 3988 (a sorbitol based nucleator/clarifier in sample C4) showed slight increase in YI compared to other samples (i.e., sample A4 with HPN-68, Sample B4 with NA-21). Note that the specific concentrations of nucleators/clarifiers were chosen, because they are known to improve clarity/nucleation at these levels. It was also evident that addition of 10% ENGAGE ® 8200 (i.e., sample D4) resulted in higher multiaxial energy, compared to other formulations.

TABLE 5

| | Sample ID | | | | | |
|---|---|---|---|---|---|---|
| | A4 | B4 | C4 | D4 | E4 | F4 |
| PP Powder | 99.625 | 99.575 | 99.55 | 89.525 | 99.5 | 99.575 |
| MFR 9 dg/min. | | | | | | |
| Chimassorb 944, wt % | 0.15 | 0.15 | 0.15 | 0.15 | 0.15 | — |
| Genox EP, wt % | 0.05 | 0.05 | 0.05 | 0.05 | 0.05 | — |
| FS410, wt % | — | — | — | — | — | 0.2 |
| Calcium Stearate, wt % | 0.05 | 0.05 | 0.05 | 0.05 | 0.05 | 0.05 |
| HPN-68, % | 0.125 | — | — | 0.075 | 0.1 | — |
| NA-21, wt % | — | 0.175 | — | — | — | 0.175 |
| Millad 3988, wt % | — | — | 0.2 | 0.15 | 0.15 | — |
| Engage 8200, wt % | — | — | — | 10% | — | — |

Physical Properties
at 0 Mrads

| | | | | | | |
|---|---|---|---|---|---|---|
| MFR (g/10 min) | 11 | 11 | 11 | 12 | 11 | 11 |
| % Strain @ Yield | 13.3 | 14.3 | 14.4 | 16.6 | 13.9 | 14.3 |
| Stress @ Yield, psi | 3990 | 4060 | 4110 | 3360 | 4240 | 4240 |
| % Strain @ Break | 670 | 660 | 620 | 830 | 660 | 650 |
| Stress @Break, psi | 2650 | 2680 | 2700 | 2500 | 2710 | 2710 |
| Multi-axial Impact @23° C., | 117 | 346 | 190 | 319 | 140 | 96 |
| (in-lbs) | | | | | | |
| Yellowness Index | 0.47 | 0.5 | 1.52 | −1.65 | 1.13 | 1.34 |
| % Haze - 25 mil | 24.7 | 7.9 | 5.4 | 19.5 | 11.5 | 6.3 |
| % Haze - 50 mil | 47.4 | 19.4 | 10.6 | 46.2 | 23.5 | 13.1 |

at 2.5 Mrads

| | | | | | | |
|---|---|---|---|---|---|---|
| MFR (g/10 min) | 63 | 66 | 71 | 56 | 55 | 54 |
| % Strain @ Yield | 12.7 | 13.9 | 14.8 | 16.6 | 14.3 | 14.3 |
| Stress @Yield, psi | 4050 | 4150 | 4040 | 3370 | 4040 | 4170 |
| % Strain @ Break | 610 | 580 | 530 | 810 | 660 | 670 |
| Stress @ Break, psi | 2550 | 2600 | 2630 | 2430 | 2630 | 2620 |
| Multiaxial Impact @ 23° C., | 81 | 215 | 136 | 311 | 80 | 82 |
| in-lbs | | | | | | |
| Yellowness Index | 1.3 | 1.52 | 2.55 | 0.69 | 2.35 | 2.44 |

at 5 Mrads

| | | | | | | |
|---|---|---|---|---|---|---|
| MFR (g/10 min) | 72 | 115 | 95 | 99 | 103 | 103 |
| % Strain @ Yield | 13.56 | 14.3 | 14.3 | 16.1 | 13.8 | 14.8 |
| Stress @ Yield, psi | 3930 | 4040 | 4180 | 3520 | 4180 | 4080 |
| % Strain @ Break | 460 | 650 | 630 | 880 | 660 | 540 |
| Stress at Break, psi | 2540 | 2440 | 2560 | 2430 | 2580 | 2560 |
| Multiaxial Impact @23° C., in- | 29 | 128 | 36 | 301 | 30 | 42 |
| lbs | | | | | | |
| Yellowness Index | 1.76 | 1.86 | 2.87 | 0.59 | 2.21 | 2.52 |

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

What is claimed is:

1) A blend useful as an additive in polyolefin polymers for minimizing the effects of radiation on the physical properties of said polymers, which comprises a hindered amine light stabilizer and at least one material selected from the group consisting of: i) amine oxides exemplified by the formula: 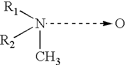
in which R₁ and R₂ are each independently selected from C₁₀ to C₂₄ alkyl, aryl, or alkylaryl groups, whether straight-chain, branched, cyclic, saturated, or unsaturated; and ii) hydroxylamines exemplified by the formula: 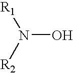
in which R₁ and R₂ are each independently selected from C₁₀ to C₂₄ alkyl, aryl, or alkylaryl groups, whether straight-chain, branched, cyclic, saturated, or unsaturated.

2) A polymerized olefin polymer composition comprising:
a polymer, and
a blend that comprises a hindered amine light stabilizer and at least one material selected from the group consisting of: i) amine oxides exemplified by the formula: 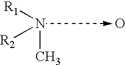
in which R₁ and R₂ are each independently selected from C₁₀ to C₂₄ alkyl, aryl, or alkylaryl groups, whether straight-chain, branched, cyclic, saturated, or unsaturated; and ii) hydroxylamines exemplified by the formula: 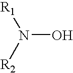
in which R₁ and R₂ are each independently selected from C₁₀ to C₂₄ alkyl, aryl, or alkylaryl groups, whether straight-chain, branched, cyclic, saturated, or unsaturated.

3) An olefin polymer according to claim 2 wherein said polymer is selected from the group consisting of: propylene homopolymers, propylene co-polymers, ethylene homopolymers, and ethylene co-polymers, wherein when said olefin polymer comprises a co-polymer of either propylene or ethylene, said co-polymer is a co-polymer which was formed in the presence of at least one monomer comprising a C₂ to C₈ mono-olefin.

4) A composition according to claim 2 which further comprises a sorbitol-based clarifier present in any amount between 500 ppm and 5000 ppm by weight based on the total weight of said polymer.

5) A composition according to claim 2 which further comprises an inorganic clarifier present in any amount between 500 ppm and 5000 ppm by weight based on the total weight of said polymer.

6) A composition according to claim 2 which further comprises an inorganic nucleator present in any amount between 250 ppm and 2500 ppm by weight based on the total weight of said polymer.

7) A composition according to claim 2 wherein an amine oxide is present, and wherein the ratio of amine oxide to hindered amine light stabilizer is any ratio in the range of between about 1:0.2 to 1:5.

8) A composition according to claim 2 wherein a hydroxyl amine is present, and wherein the ratio of hydroxyl amine to hindered amine light stabilizer is any ratio in the range of between about 1:0.5 to 1:5.

9) The composition of claim 2 further comprising a neutralizer.

10) An article of manufacture that is fabricated from a composition according to claim 2.

11) A process for providing a sterilized article of manufacture which comprises the steps of:
a) providing an article according to claim 10; and
b) exposing said article to a source of radiation selected from the group consisting of: gamma radiation and electron beam radiation.

12) An article made by a process according to claim 11 wherein the propylene polymer is predominantly comprised of a random copolymer of propylene and ethylene, which random co-polymer contains between about 0.5% to about 8% of ethylene by weight based on the total weight of the polymer.

13) A composition according to claim 1 wherein an amine oxide is present, and wherein the ratio of amine oxide to hindered amine light stabilizer is any ratio in the range of between about 1:0.2 to 1:5.

14) A composition according to claim 1 wherein a hydroxyl amine is present, and wherein the ratio of hydroxyl amine to hindered amine light stabilizer is any ratio in the range of between about 1:0.5 to 1:5.

15) A composition according to claim 2 wherein the blend is present in any amount between about 500 ppm and 5000 ppm by weight based on the total weight of said polymer.

16) A composition according to claim 9 wherein the neutralizer comprises a hydrotalcite or a metallic stearate.

17) An article of manufacture according to claim 10 wherein the article is selected from the group consisting of:a syringe, a pouch, a film, a tube, a labware and a medical kit.

18) A process according to claim 11 wherein exposing said article to a source of radiation comprises exposing said article to a total amount of radiation which is no greater than about five megarads.
